(19) United States
(12) Patent Application Publication
(10) Pub. No.: US 2017/0185995 A1
(43) Pub. Date: Jun. 29, 2017

(54) MODULE FOR EMULATING AT LEAST ONE PAYMENT CARD, CORRESPONDING METHOD, PAYMENT DEVICE, COMPUTER PROGRAM PRODUCT AND STORAGE MEDIUM

(71) Applicant: INGENICO GROUP, Paris (FR)

(72) Inventors: David Naccache, Paris (FR); Laurent Mayer, Courdimanche (FR); Bilal El Kouche, Saint Denis (FR)

(21) Appl. No.: 15/305,048

(22) PCT Filed: Apr. 17, 2015
(86) PCT No.: PCT/EP2015/058375

§ 371 Date: Oct. 18, 2016

(30) Foreign Application Priority Data
Apr. 18, 2014 (FR) 1453544

(51) Int. Cl. G06Q 20/34; G06Q 20/10; G06Q 20/32

(52) U.S. Cl. CPC G06Q 20/351; G06Q 20/322; G06Q 20/102

(57) ABSTRACT

A module for emulating a payment card, providing a corresponding emulated card. The module is integrated into a secure enclosure of a communication terminal and is configured to receive a request from an administration module installed in the communication terminal; obtain an item of data representative of the payment card, known as card data, during a payment operation involving the emulated card and requiring the card datum obtained; and communicate with a payment acquisition module of a payment device, via a communication module of the payment device. The emulated card can be used in a plurality of successive payment operations.

### 1 FIELD OF THE INVENTION

The present invention relates to the field of payment by bank card and more particularly to payment by virtual bank card.

### 2 PRIOR ART SOLUTIONS

There are numerous solutions that make it possible to do without real/physical bank cards for making payments, especially payments by Internet, made from a user's communications terminal (computer, personal assistant, tablet, smartphone, etc). One of the main issues at stake in these solutions is the security of the payment.

Thus, many banking institutions offer their customers solutions for making online payments without using the physical bank card number. To this end, it is generally sufficient to install a software program on one's terminal and obtain a number that will be valid for only one payment and that will be incapable of being recognized by web hackers if any.

The major drawback of these systems therefore lies in the fact that the number obtained is temporary and can be used only for one payment. These systems therefore make it possible to replace a bank card by the generation of one bank card number per payment, but cannot be used to replace a bank card by a virtual card with a number that could be used for all payments.

There are other types of approaches in which only one physical payment card is used to emulate one or more bank cards (as well as loyalty cards, pre-paid cards etc). To this end, the pieces of data representing the cards to be emulated are loaded into the single card which is then used as a classic bank card and must therefore be presented for each payment. The use of this unique payment card calls for a choice on the part of the user of the emulated bank card to use a card for a given payment and does not enable online payment (unless the user enters the number of the card to be used, with all the insecurity related to such entry).

There is therefore a need for an approach to emulating a physical payment card offering optimum security guarantees for each payment, while at the same time optimizing the ergonomic advantages for the user.

### 3 SUMMARY OF THE INVENTION

The invention relates to a module for emulating at least one payment card, providing a corresponding emulated card.

According to the invention, the module is integrated into a secured enclosure of a communications terminal and comprises:
means for receiving at least one request coming from at least one administration module installed in the communications terminal;
means for obtaining at least one piece of data representing the payment card, called card data;
means for communicating with at least one payment-acquisition module of a payment device, via at least one communications module of the payment device, the means for communicating being activated during a payment operation involving the emulated card and requiring at least the card data obtained,
   the emulated card being capable of being involved in a plurality of successive payment operations.

Thus, the invention proposes a novel and inventive approach to the emulation of a payment card in a communications terminal (for example a computer, a personal assistant, a tablet, a smartphone etc) making it possible to do without a physical payment card for a plurality of payments while at the same time obtaining the advantages of use of such a card, namely its use for any payment within the classic limits of use of such a payment card (expiry date, spending limits etc).

Thus, the invention according to its different embodiments enables the emulation of a physical payment card, by obtaining (through downloading for example) the data representing the card needed to carry out a payment operation so as to be able to communicate this data, as if it were being read on the physical payment card, to a payment-acquisition module requiring this data for a given payment operation.

Thereafter, this emulated card can be used for a plurality of payment operations like a classic physical payment card (again within the classic limits of use of such a payment card such as the expiry date, spending limits etc).

Thus, the ergonomic value of the card is clearly optimized for a user as compared with existing solutions, proposed by banking institutions especially, in which a temporary bank card number is generated for each payment. Indeed, the user only has to choose the emulated card that he wishes to use for a given payment without entering the bank card number etc.

In addition, since the emulation module is integrated into a secured enclosure of the communications terminal, the optimal security guarantees are provided.

In particular, the piece or pieces of data representing the card, called card data, are the classic bank data elements needed to implement a payment operation or a banking transaction. For example, a bank card is characterized by a unique number defined by the ISO/IEC 7812 international standard.

The payment device is for example, a module integrated also into the communications terminal, in a secured enclosure, and comprises a communications module and a payment-acquisition module. This communications module makes it possible firstly to communicate with a payment card reader (internal or external to the communications terminal) so as to obtain the data of the payment card needed for a payment operation or again makes it possible to communicate with the payment card emulation module according to the invention. The communications module makes it possible secondly to communicate with the payment-acquisition module in charge of the payment operation proper so as to provide it with the card data preliminarily obtained and required for the validation of the payment operation.

According to certain embodiments of the invention, the administration module is a software module used to manage the different cards emulated by the payment card emulation module according to the invention, i.e. to install/create new emulated cards and de-install certain emulated cards. For example, this administration module sends out requests to the payment card emulation module to install a new emulated card and thus activate the means used to obtain payment data or to de-install an emulated card and, for example, erase all the payment data pertaining to it. This administration module can have a user interface enabling the installation and the de-installation of emulated cards when the user of the communications terminal wishes it.

According to one particular characteristic of the invention, the means for obtaining are activated when the means for receiving receive an installation request sent out by the administration module.

Thus, according to this embodiment of the invention, the administration module sends out a request for installing a new emulated card to the payment card emulation module via its means for receiving. The reception of this installation request triggers the activation of the means for obtaining card data, for example, in the form of a downloading of the data of the physical bank card to be emulated. The payment card emulation module is then capable of providing a new emulated card to be used according to the user's choice for one or more payment operations.

According to one particular aspect of the invention, the emulation module additionally comprises means for storing card data obtained by the means for obtaining.

Thus, according to this embodiment of the invention, the emulation module stores the preliminarily obtained card data (for example in the form of a downloading of the data of the physical bank card to be emulated), so as to have this data available at any time to communicate it to the payment-acquisition module.

According to one particular embodiment of the invention, the storage of the data of an emulated card is associated with an identifier which then makes it possible to de-install the emulated card when this is requested by the administration module.

According to one particular characteristic of the invention, the emulation module comprises means for de-installing at least one emulated card activated at the reception, by the means for receiving, of a request for de-installing the emulated card sent out by the administration module.

Thus, according to this embodiment of the invention, the reception, by the means for receiving of the payment card emulation module, of a de-installation request sent out by the administration module triggers the activation of the means for de-installing an emulated card, for example, in the form of the erasure of the stored data on this emulated card to be de-installed.

The de-installation request sent out by the administration module contains for example an identifier of the emulated card to be de-installed in the form of a parameter of the request, this identifier being associated for example with the emulated card at the time of its creation and more particularly at the time of the storage of the payment data pertaining thereto.

In particular, the means for communicating communicate with the communications module of the payment device according to the ISO 7816 standard.

Thus, according to this embodiment of the invention, the data transmitted between the means for communicating of the emulation module and the communications module of the payment device travels through an ISO 7816 buffer as if it were data read from a physical payment card via a card reader. In this way, the payment-acquisition module of the payment device cannot detect whether the card data has come from a payment card emulation module or from a physical payment card. The same guarantees of security are therefore obtained with the payment card emulation module as with a physical card reader.

According to one particular embodiment of the invention, the emulation module is integrated into the payment device.

Thus, according to this embodiment of the invention, the payment card emulation module is integrated into a payment device which is itself present in a communications module within a secured enclosure.

In this way, a user in possession of the communications module can make payments without adding any external module to his communications terminal and by using, if he so wishes, a same emulated payment card to make all his payments in full security.

Indeed, according to the different embodiments of the invention, the user can have a plurality of emulated payment cards available to make payments through a payment device integrated into his communications terminal. In practice, starting from the time when his payment physical card is emulated in his communications terminal, the user no longer has need of this physical payment card when he wishes to make a payment through his communications terminal, nor does he need to enter a temporary virtual card number for each payment. The user must simply select the emulated payment card to be used for a given payment.

The invention also relates to a payment device comprising an emulation module as described here above.

The invention also relates to a method for emulating at least one payment card providing a corresponding emulated card.

According to the invention, the method is implemented by a payment card module emulation module integrated into a secured enclosure of a communications terminal and comprising:
a step for receiving at least one request coming from an administration module installed in the communications terminal;
a step for obtaining at least one piece of data representing the payment card, called card data;
during a payment operation involving the emulated card and requiring at least the obtained card data, a step for communicating with at least one payment-acquisition module of a payment device via at least one communications module of the payment device,
   the emulated card being capable of being involved in a plurality of successive payment operations.

The invention also pertains to a computer program downloadable from a communications network and/or stored in a computer-readable carrier and/or executable by a processor, comprising program code instructions for executing the method as described here above, when it is executed by a processor, as well a computer-readable and non-transient storage medium or information carrier storing a computer program comprising a set of instructions executable by a computer or a processor to implement the method as described here above.

### 4 LIST OF FIGURES

Other features and advantages of the invention shall appear more clearly from the following description of a particular embodiment, given by way of a simple, illustratory and non-exhaustive example, and from the appended drawings, of which:

FIG. 1 presents a first example of a system into which a payment card emulation module is integrated according to a first embodiment of the invention;

FIG. 2 presents a second example of a system into which a payment card emulation module is integrated according to a second embodiment of the invention;

FIG. 3 presents an example of an architecture of a payment card emulation module according to one embodiment of the invention;

FIG. 4 presents the main steps of the payment card emulation method according to one embodiment of the invention.

### 5 DETAILED DESCRIPTION OF THE INVENTION

### 5.1 General Principle

The general principle of the invention consists of the emulation of a user's real bank card so as to enable this user to carry out payment operations without presenting his real payment card. In particular, the invention in its different embodiments can be applied to payments made by means of a user's communications terminal such as a computer, a personal assistant, a tablet, a smartphone etc.

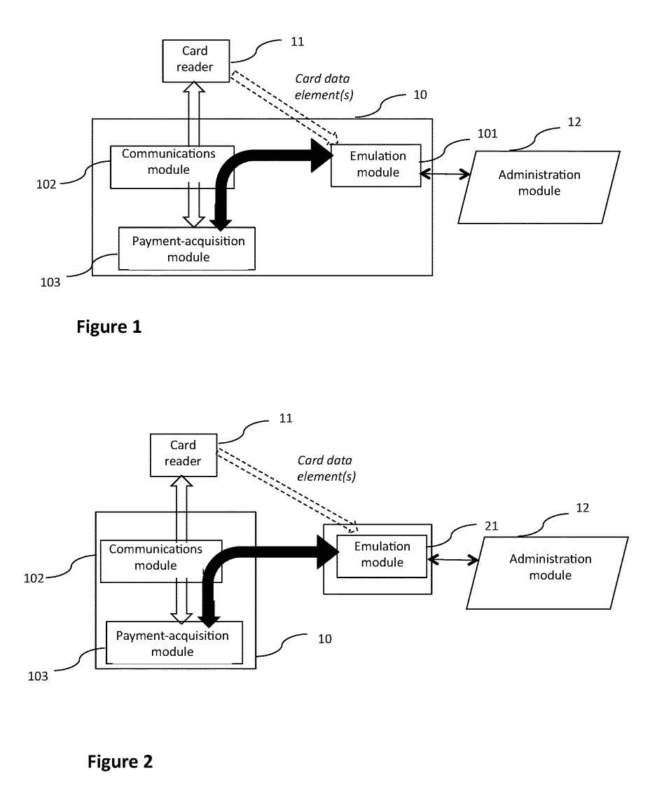

According to the different embodiments of the invention, such a system enabling the implementing of payment operations (illustrated for example in FIGS. 1 and 2) presents a payment device 10 for example integrated, in the form of an integrated circuit, into the user's communications terminal (not shown) in a secured enclosure and a payment card reader 11.

The payment device 10 can carry out payment operations especially through the reading, via the card reader 11, of data of a user's real payment card. To this end, the payment device 10 has especially a communications module 102 and a payment-acquisition module 103. The communications module 102 is used especially to retrieve data read from the real payment card in order to communicate this data subsequently to the payment-acquisition module 103 to carry out payment operations. The communications module 102 also enables the payment device 10 to carry out a secured communication to a bank server in order to perform or finalize a transaction (communications not illustrated).

The general principle of the invention therefore consists in emulating a user's real payment card through an emulation module (101, 21) while at the same time preserving the above-described operation for the running of a payment operation. Thus, the communications module 102 and the acquisition module 103 of the payment device 10 cannot distinguish a real card from an emulated card. In this way, the rules of security are especially guaranteed during the use of an emulated card in the same way as during the use of a real payment card.

Here below, reference is made to the emulation of a real payment card but the different embodiments of the invention enable the emulation of a plurality of payment cards.

### 5.2 Description of a First Embodiment

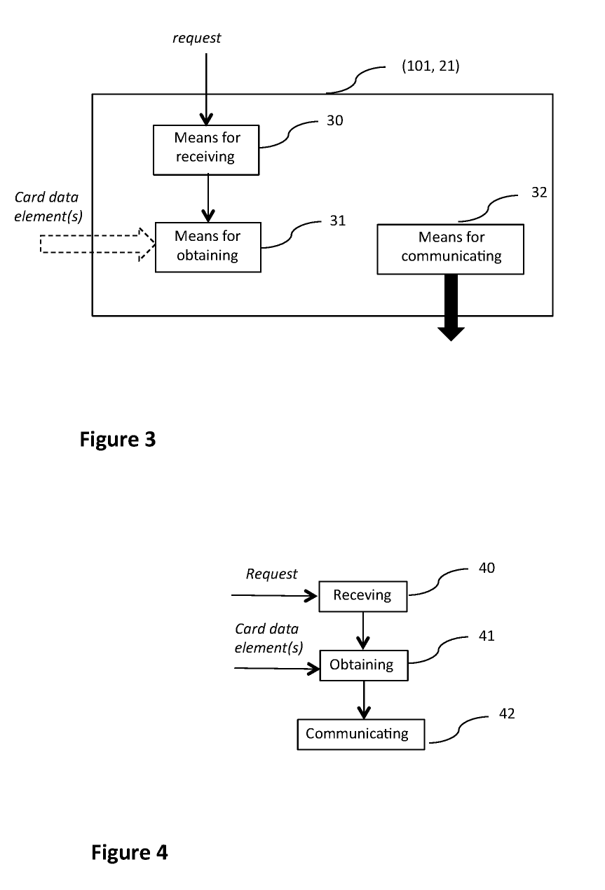

FIGS. 1 and 3 illustrate a first embodiment of the invention in which the payment card emulation module 101 is situated within a payment device 10, itself integrated into a communications terminal within a secured enclosure. Thus, the electronic components forming the payment card emulation module are integrated into the integrated circuit forming the payment device, which is itself present within a secured enclosure of the communications terminal.

According to this first embodiment of the invention, we consider for example a user possessing a computer into which a payment device is integrated in a secured way, enabling him to use a corresponding software application to make payments with his real payment card. To this end, a payment card reader 11 is also available in the form of an external module connected to the computer or an internal module integrated into the computer. This payment card reader 11 can be used especially to read the data of a card inserted by the user in order to carry out the payment operation in the classic manner of an electronic payment terminal.

When no payment operation is in progress, it is preferable as well as more practical for the user not to leave the payment card inserted in the card reader. Indeed, for reasons of security, it is preferable that the card should not be constantly available for reading. Besides, the user could need his card to make other payments without his computer or could need to withdraw cash from a cash-dispensing machine.

This operation implies firstly that the user will have his real payment card available in proximity to his computer when he wishes to make a payment via the payment device integrated into his computer and, secondly, that he will remove it when these payment operations are not being performed.

The invention, in its different embodiments, improves ergonomic quality for the user when he makes payment through the payment device integrated into his computer. It does so by enabling him to use an emulated card, corresponding to his real payment card, for all payments made through this device without obliging him to present his real payment card. At the same time, the security guarantees required for a payment operation are preserved.

To this end, the payment card emulation module 101 makes it possible to create/install one or more emulated cards, use them for a plurality of payment operations, via the above-mentioned payment device as well to de-install them if necessary.

The invention, according to different embodiments, provides for the possibility of the payment card emulation module 101 being administered by an administration module 12 so as to manage the installation of emulated cards as well as their de-installation.

Thus, this administration module 12, for example a software module having a user interface enabling the user to manage the emulated cards available in his computer, sends out requests for installing or de-installing cards intended for the emulation module 101.

For example, when the user wishes to have a new emulated payment card available in his computer, he can make a request, through the user interface of the administration module 12, for the installation of this new card from a real card inserted into the card reader 11. Similarly, when the user wishes to de-install an emulated card, for example, because the corresponding real card has reached its expiry date or because he wishes to sell or lend his computer, he can make a request, through the interface user of the administration module 12, for the de-installation of a given emulated card.

As illustrated in FIG. 3, the payment card emulation module 101 therefore has available means for receiving 30 requests coming from the administration module 12.

Thus, when a request for installing a card to be emulated is received by its means for receiving 30, the means for obtaining 31 are activated to obtain at least one piece of data representing the real card to be emulated, also called Card Data Element(s). Once the data needed for emulation is obtained, the real payment card is therefore emulated and available for use, in a virtual way, for any payment operation. The user can then withdraw the real card from the reader and no longer use it for payments through his communications terminal.

According to one particular embodiment of the invention, the pieces of data obtained are stored by the emulation module 101 via means for storing (not shown) and are for example identified by a unique identifier thereafter enabling the emulated card to be retrieved (especially during a de-installation request).

Then, when a payment operation requires the use of a payment card and when the user chooses to use this emulated card, the means for communicating 32 of the emulation module 101 communicate with the communications module 102 of the payment device 10, for example, to give it the preliminarily obtained and stored card data.

For example, this communication is implemented via an ISO 7816 buffer (ISO 7816 being the main standard for smart cards) in such a way that the communications module 102 of the payment device 10 cannot detect the fact that the card used for the payment is an emulated card. The security guarantees are therefore optimal, as in the case of the use of a real payment card.

On the user side, the implementing of a payment operation via an emulated card is made possible for example, through a user interface, enabling especially the user to choose the emulated card to be used, with the possibility of pre-defining a default card (for example the user's main payment card). The user can also have to choose between a real card inserted into the reader and one or more emulated cards.

The user can therefore use an emulated card, according to the different embodiments of the invention, for as many payment operations as he wishes in full security and without having to furnish his real payment card.

Finally, when a request for de-installation sent out by the administration module 12 is received by the means for receiving 30 of the emulation module 101, means (not shown) for de-installing the emulation module 101 are activated, for example so as to erase all the data on the emulated card to be de-installed. To this end, the identifier associated with the emulated card at the time of its creation/installation can be transmitted in the request so that the means for de-installing know which card has to be de-installed.

### 5.3 Description of a Second Embodiment

FIGS. 2 and 3 illustrate a second embodiment of the invention in which the payment card emulation module 21 is situated within a secured enclosure of a communications terminal in which a payment device 10 is itself also integrated (for example in the form of an integrated circuit) within a secured enclosure (distinct from or identical with that of the emulation module).

Thus, the emulation module 21 can be integrated into a SIM card present in the communications terminal or in any other secured place of the communications terminal.

All the characteristics described with reference to the first embodiment can be reproduced in this second embodiment, the communications between the card emulation module 21 and the communications module 102 of the payment device 10 being done in a secured manner between two secured enclosures of the same communications terminal, as illustrated in FIG. 2.

### 5.4 Payment Card Emulation Method

FIG. 4 for its part illustrates the main steps of the payment card emulation method enabling a corresponding emulated card to be provided, according to the different embodiments of the invention.

This method, implemented by a payment card emulation module (as described here above according to the different embodiments of the invention) integrated within a secured enclosure of a communications terminal, comprises a first step 40 for receiving at least one request coming from at least one administration module installed in the communications terminal.

This request can be a request for installing an emulated card corresponding to the real payment card and is followed by a step 41 for obtaining at least one piece of data representing the real payment card, called a piece of card data.

If the request is a request for de-installing an emulated card, it is then followed by a step of de-installation (not shown) erasing, for example, all the data on the emulated card to be de-installed.

Then, during a payment operation involving the emulated card and requiring at least one preliminarily obtained piece of card data, a step for communicating 42 is implemented with at least one payment-acquisition module of a payment device, via at least one communications module of this payment device. For example, and as illustrated in FIGS. 1 and 2, the payment device is itself integrated into the communications terminal, in a secured enclosure, and enables the user to carry out payment operations via his communications terminal.

As already indicated, in variants of the invention, the payment card emulation module implementing the steps of the method for emulating can be integrated into the payment device, or it can be placed in the same secured enclosure, or it can be situated in another secured enclosure of the communications terminal.

According to the different embodiments of the invention, the emulated card is capable of being involved in a plurality of successive payment operations.

1. Module (101, 21) for emulating at least one payment card, providing a corresponding emulated card, characterized in that said module is integrated into a secured enclosure of a communications terminal and in that it comprises:
means (30) for receiving at least one request coming from at least one administration module (12) installed in said communications terminal;
means (31) for obtaining at least one piece of data representing said payment card, called card data, via a payment card reader connected with or integrated into said communications terminal;
means (32) for communicating with at least one payment-acquisition module (103) of a payment device (10), via at least one communications module (102) of said payment device (10), said means for communicating being activated during a payment operation involving said emulated card and requiring at least said card data obtained,
said emulated card being capable of being involved in a plurality of successive payment operations.

2. Emulation module according to claim 1, characterized in that said means for obtaining are activated at reception, by said means for receiving, of an installation request sent out by said administration module.

3. Emulation module according to claim 1, characterized in that it furthermore comprises means for storing at least said card data obtained by said means for obtaining.

4. Emulation module according to claim 1, characterized in that it comprises means for de-installing at least one emulated card, activated at the reception, by said means for receiving, of a request for de-installing said emulated card sent out by said administration module.

5. Emulation module according to claim 1, characterized in that said means for communicating communicate with said communications module of said payment device according to the ISO 7816 standard.

6. Emulation module according to claim 1, characterized in that it is integrated into said payment device.

7. Payment device, characterized in that it comprises an emulation module according to any one of the claims 1 to 6.

8. Method for emulating at least one payment card, providing a corresponding emulated card, characterized in that said method is implemented by a payment card emulation module integrated into a secured enclosure of a communications terminal and in that it comprises:
a step for receiving at least one request coming from at least one administration module installed in said communications terminal;
a step for obtaining at least one piece of data representing said payment card, called card data, via a payment card reader connected with or integrated into said communications terminal;
during a payment operation involving said emulated card and requiring at least said card data obtained, a step for communicating with at least one payment-acquisition module of a payment device via at least one communications module of said payment device,
said emulated card being capable of being involved in a plurality of successive payment operations.

9. Computer program downloadable from a communications network and/or stored in a computer-readable carrier and/or executable by a processor, characterized in that it comprises program code instructions for executing the method according to any one of the claims 1 to 6, when it is executed by a processor.

10. Computer-readable and non-transient storage medium storing a computer program comprising a set of instructions executable by a computer or a processor to implement the method according to any one of the claims 1 to 6.
